(19) United States
(12) Patent Application Publication
(10) Pub. No.: US 2003/0108695 A1
(43) Pub. Date: Jun. 12, 2003

(54) Polyethylene terephthalate disposable tumblers

(76) Inventors: Michael A. Freek, Bradford (CA); Ottavio Di Minno, Scarborough (CA); Dan Weissman, Simsbury, CT (US); Erland R. Sandstrom, Menasha, WI (US); David H. Hollenberg, Kaukauna, WI (US)

Correspondence Address: Ferrells, PLLC, P.O. Box 312, Clifton, VA, 20124-1706, US

(21) Appl. No.: 10/205,974

(22) Filed: Jul. 26, 2002

Related U.S. Application Data
(60) Provisional application No. 60/315,299, filed on Aug. 28, 2001.

(51) Int. Cl. B29C 49/06; B29C 49/64; B32B 1/02

(52) U.S. Cl. 428/34.1; 264/537; 264/528; 264/232

(57) ABSTRACT

A method of making a disposable tumbler includes: injection molding a polyethylene terephthalate resin in an annular mold cavity defined by an injection mold wall and a core to form a resinous parison on the core; separating the parison from the injection mold wall by moving the parison on the core away from the mold wall; moving the parison on the core into alignment with a blow-mold; and expanding the parison by directing a pressurized fluid to its interior such that the parison separates from the core and expands to the surface of the blow mold to form the tumbler, wherein the parison is radially expanded by a factor of at least about 2.6 at its base to form the tumbler. Typically, the parison is radially expanded at its base by a factor of from about 2.6 to about 3.25 to form the tumbler; whereas preferably the parison is expanded by a factor of from about 2.7 to about 2.9. In preferred embodiments of the method, the mold core is provided with a microtextured surface which may be provided by way of vapor-honing to provide a tumbler which resists nest-lock. Moisture, judiciously applied, may likewise alleviate nest-lock. The annular mold cavity is generally thicker than similar cavities which may be employed with polystyrene, for example.

### CLAIM FOR PRIORITY

This non-provisional application claims the benefit of the filing date of U.S. Provisional Patent Application Serial No. 60/315,299, of the same title, filed Aug. 28, 2001.

### TECHNICAL FIELD

The present invention relates generally to disposable tumblers and more specifically to lightweight injection blow-molded tumblers made of polyethylene terephthalate (“PET”) by employing relatively high dilation of the injection molded parison. A particularly preferred product is a nominal 16 ounce container volume disposable tumbler with a relatively low sidewall taper provided with a fortified brim made from less than about 18 grams of resin which has an interior surface microtexture which resists nesting lock when the articles are stacked.

### BACKGROUND

Disposable polymeric articles for packaging, bowls and cups and the like are well known. Such articles are formed of any one of a plethora homopolymer or copolymer resins such as polystyrenes, polypropylenes, polyethylenes, polycarbonates, polyethylene terephthalates and the like and may be made by thermoforming, injection molding, injection blow-molding, or any other suitable technique. Injection molding has advantages in that a short cycle time is readily achieved, but tends to be more expensive in terms of material and articles so formed tend to have anisotropic properties and therefore exhibit brittleness. Thermoforming likewise tends to have advantageous cycle times, however, the waste generated tends to be excessive. Moreover, the draw which may be imposed on the sheet is limited. U.S. Pat. No. 5,693,278 discloses thermoformed articles produced from polyethylene terephthalate sheet. The excessive waste problem is addressed in the '278 patent by utilizing at least forty percent (40%) by weight recycled material.

U.S. Pat. No. 5,433,337 of Willbrandt discloses an injection molded drink container to fit in vehicle cup holders. The container has an upper rim 20 with a height of from about 1/16 of an inch to about 1/10 of an inch and a width of from about 0.15 inches to about 0.25 inches. Note Col. 5 at lines 15-25. U.S. Pat. No. 5,427,269 notes at Col. 5 that this type of container may be produced by any suitable method, but that injection molding is preferred. In the '337 and '269 patents it is noted that the plastic cup may be made by injecting molten plastic into a mold of progressively increasing dimension in the direction of flow of the plastic. The lower portion of the cup thus has an increasing thickness of from about 20 thousandths of an inch (mils) to about 44 mils. See also Canadian Patent Application Serial No. 2,168,986; PCT Publication WO 95/19253 and United States Design Patent No. 362,368.

As noted hereinabove, injection molding tends to be expensive in terms of material, requiring relatively thick-walled parts to compensate for the anisotropy inherent in the production technique. Disposable containers are preferably made utilizing as little material as possible. Likewise, while a stronger material such as polyethylene terephthalate may be preferred in some applications, its application in the disposable tumbler market has been limited due to its relatively high cost.

Injection blow-molding processes and apparatus are well known and used mostly for producing bottles and like storage containers. For example, reference may be had to U.S. Pat. No. 3,183,552 to Farkas, U.S. Pat. No. 3,819,314 to Marcus, U.S. Pat. No. 3,339,231 to Piotrowski and Canadian Patent No. 995,418 to Cannon et al. U.S. Pat. Nos. 4,225,304; 4,230,298; 4,234,302 and 4,308,086, issued to Valyi, disclose a continuous process and apparatus for blow-molding, including injection blow-molding, containers formed of various plastics.

U.S. Pat. No. 4,540,543 assigned to Canada Cup, Inc., discloses an injection blow-molding process and apparatus for hollow plastic articles. The method and apparatus for injection blow-molding hollow plastic articles is characterized by a rapid and efficient operating cycle. The injection mold includes a mold cavity and the blow mold is located adjacent the mold cavity in a side-by-side relationship. The parison is injection molded into the mold cavity onto a core. The parison on the core is separated from the mold cavity by moving the parison on the core axially in a straight path away from the mold cavity, followed by movement in a substantially arcuate path into axial alignment with the blow mold, followed by axial movement in a straight path into the blow mold. The advantage of the method and apparatus of injection blow-molding disclosed in U.S. Pat. No. 4,540,543 compared to other injection blow-molding methods is in its reliability, preventing interruptions of the injection blow-molding operation, and the simultaneous injection molding and blow-molding cycle for multiple articles leading to greater efficiency. The method and apparatus as disclosed in U.S. Pat. No. 4,540,543 have been used to manufacture thin walled containers from polystyrene.

### SUMMARY OF INVENTION

It has been found in accordance with the present invention that disposable polyethylene terephthalate tumblers are advantageously produced by injection blow-molding wherein the injection molded parison is dilated with relatively high expansion ratios to make the tumbler. For example, a lightweight nominal 16 ounce container volume polyethylene terephthalate tumbler is made from less than about 18 grams of resin by forming a relatively thick parison of low weight by injection molding and expanding the parison 2.8 times or so in the blow mold. A method of making a disposable tumbler by way of the inventive process thus includes: injection molding polyethylene terephthalate resin in an annular mold cavity defined by an injection mold wall and a core to form a resinous parison on the core; separating the parison from the injection mold wall by moving the parison on the core away from the mold wall; moving the parison on the core into alignment with a blow-mold; and expanding the parison by directing a pressurized fluid to its interior such that the parison separates from the core and expands to the surface of the blow mold to form the tumbler, wherein the parison is radially expanded by a factor of at least about 2.6 at its base when forming the tumbler. Typically, the parison is radially expanded at its base by a factor of from about 2.6 to about 3.25 to form said tumbler; whereas preferably the parison is radially expanded at its base by a factor of from about 2.7 to about 2.9.

In preferred embodiments of the method, the mold core is provided with a microtextured surface which may be provided by way of a technique selected from the group consisting of vapor honing, grit blasting, lapping, or chemical etching. Most preferably, the microtextured surface of the core (which corresponds to the inner surface of the parisons and the tumblers) is provided by vapor-honing. The core surface may be vapor-honed with a pneumatic sand-blasting apparatus utilizing an air pressure of from about 30 to 100 psi (pounds per square inch, gauge) and glass beads having a size in the range of from about 70 to about 100 mesh. The annular mold cavity is generally thicker than similar cavities which may be employed with polystyrene, for example. The annular mold cavity may have an annular thickness at its portion corresponding to the base of the parison of from about 35 thousandths of an inch (mils) to about 45 mils. An average annular mold cavity thickness at its portion corresponding to the base of the parison is typically from about 37 mils to about 43 mils.

In order to provide for temperature control, the core is provided with a cooling channel adapted to receive cooling water which is supplied to said core at a temperature of about 180° F. or so and maintained in the core at a maximum temperature of about 195° F. Maintaining the cooling water in the core at about 185° F. is typical. The core may be an elongate core having a rod portion underlying the sidewalls of the parison and having a nose portion underlying the end portion of the parison and wherein the rod portion is provided with at least one spiral cooling channel and the nose portion of the core is provided with a cooling channel within about 0.15 inches of the surface of the nose portion. A cooling channel within about 0.125 inches of the surface of the nose portion is preferred.

Because of the high expansion ratios and the relatively thick parison, it is important that the core be aligned with the injection mold outer wall properly within a tight tolerance to avoid eccentric product. Generally, the injection mold wall is characterized by a centerline and the core is aligned with the centerline within a tolerance of 2 mils during the step of injection molding. Preferably, the core is aligned with the centerline within a tolerance of about 1.5 mils during the injection molding process.

In another aspect of the invention, there is provided a method of making a disposable tumbler including: (a) injection molding polyethylene terephthalate resin in an annular mold cavity defined by an injection mold wall and a core to form a resinous parison on the core, wherein the cavity is of progressively greater annular dimension from its portion corresponding to the upper sidewall portion of the parison to the base of the parison; (b) separating the parison from the injection mold wall by moving the parison on the core away from the mold wall; (c) moving the parison on the core into alignment with a blow-mold; and (d) expanding the parison by directing a pressurized fluid to its interior such that the parison separates from the core and expands to the surface of the blow mold to form the tumbler. The mold cavity typically has an annular dimension of from about 15 mils to about 30 mils at its portion corresponding to the upper sidewall portion of the parison and an annular dimension of from about 35 mils to about 45 mils at its portion corresponding to the base of the parison. In some embodiments, the mold cavity has an annular dimension of from about 37 mils to about 43 mils at its portion corresponding to the base of the parison.

In yet another aspect of the invention, there is provided an injection blow-molded polyethylene terephthalate tumbler formed by way of injection molding a parison about a core and expanding the parison by way of directing a pressurized fluid to its interior such that the parison separates from the core and expands to the surface of a blow mold to form the tumbler, wherein the parison is radially expanded at its base by a factor of at least about 2.6 when forming the tumbler. Here again, the volume of the parison is typically expanded by a factor of from about 2.6 to about 3.25 from its initial lower diameter to form the tumbler; whereas the parison is expanded by a factor of from about 2.7 to about 2.9 at its base to form the tumbler in a preferred embodiment. The injection blow-molded polyethylene terephthalate tumbler is preferably formed about a core provided with a microtextured surface such that the interior sidewall surface of the tumbler has a microtextured surface. This feature has been found to alleviate nest-lock when the tumblers are stacked as is typical with disposable products. Another way to reduce the tendency of the tumblers of the invention to lockably nest with like tumblers in a stack is by treatment of at least one surface thereof with water. Surprisingly, this treatment is effective even when the free water has been removed from the treated surfaces.

A particularly preferred product is a tumbler with a nominal container volume of about 16 ounces made from less than about 20 grams of resin and more preferably made from less than about 18 grams of resin.

In a further aspect of the invention there is provided a method of producing a stack of polyethylene terephthalate tumblers with a reduced tendency to exhibit nest-lock comprising the sequential steps of: (a) forming a plurality of polyethylene terephthalate stackable tumblers; (b) moisture-treating at least one sidewall surface of each of the plurality of polyethylene terephthalate tumblers with an amount of water effective to reduce nest-lock to a level less than that exhibited by like tumblers which have not been moisture-treated; and (c) stacking the plurality of moisture-treated polyethylene terephthalate tumblers such that said moisture-treated sidewalls are in contact with the sidewall of another tumbler in said stack. Both the inner sidewall surface and the outer sidewall surface of the tumblers may be moisture-treated; the moisture treatment typically is effective to reduce nest-lock by at least about 30 percent as compared with like tumblers that have not been moisture-treated. Preferably, the moisture treatment is effective to reduce nest-lock by at least about 40 percent as compared with like tumblers that have not been moisture-treated. The treatment is effective even when the tumblers have been dried and their surfaces are devoid of free water on their sidewalls prior to stacking. Generally, the plurality of polyethylene terephthalate tumblers have a wall caliper of from about 5 to about 30 mils, and typically have a wall caliper of from about 10 to about 25 mils.

In still yet a further aspect of the present invention there is provided a method of producing a stack of polyethylene terephthalate tumblers with a reduced tendency to exhibit nest-lock comprising: (a) forming a plurality of stackable polyethylene terephthalate tumblers each of which has at least one microtextured sidewall surface which tumblers are substantially optically clear; and (b) stacking the plurality of polyethylene terephthalate tumblers such that the microtextured sidewall surfaces contacts the sidewall of an adjacent tumbler in said stack, wherein said microtextured surfaces are operative to reduce the tendency of the tumblers to lockably nest with like tumblers. Typically, the plurality of polyethylene terephthalate tumblers have a wall caliper of from about 5 to about 30 mils, and preferably have a wall caliper of from about 10 to about 25 mils. The microtextured surfaces are operative to reduce nesting lock by at least about 30 percent and preferably the microtextured surfaces are operative to reduce nesting lock by at least about 40 percent.

In a still further aspect of the invention there is provided a nesting-lock resistant polyethylene terephthalate disposable tumbler having a wall thickness of from about 5 to about 30 mils, the tumbler being provided with a microtextured surface and being substantially optically clear, wherein the microtextured surface is operative to reduce the tendency of the tumbler to lockably nest with like tumblers when stacked but does not substantially alter the aesthetics of the optically clear tumbler. The tumbler generally has a wall caliper of from about 10 to about 25 mils and the microtextured surface is operative to reduce nesting lock by at least about 40 percent. The microtextured surface generally has a characteristic texture dimension of from about 5 microns to about 40 microns; whereas, a characteristic texture dimension of from about 10 microns to about 25 microns is typical.

The above and other features of the invention are discussed in detail below.

### BRIEF DESCRIPTION OF DRAWINGS

The invention is described in detail below with reference to the various Figures wherein like numerals designate similar parts and wherein:

FIG. 1 is an elevational schematic view showing an apparatus which may be used in the present invention to form tumblers of the present invention, the apparatus being in the closed position with the injection core in the injection mold;

FIG. 2 is a view similar to FIG. 1 with the apparatus in the open position with the injection core and parison in the midst of transfer to the blow mold;

FIG. 3 is a view similar to FIG. 1 with the apparatus in the closed position with the injection core and parison in the blow mold and with the second core in the injection mold;

FIG. 4 is a partial, expanded elevational schematic view showing additional details of the apparatus of FIG. 1;

FIG. 5 is a detailed schematic view of the ejection core engaged with the hollow article in the blow mold;

FIGS. 6 and 7 are partial schematic views showing alternate injection core embodiments;

FIG. 8 is a line chart showing core movement from injection mold to blow mold and return;

FIG. 9 is a partial schematic diagram illustrating an injection core engaged in an injection mold as may be utilized in accordance with the present invention.

FIG. 10 is an expanded view along line C-C of FIG. 9 illustrating the annular cavity between the injection mold wall and core;

FIG. 11 is a partial schematic view of the injection core of FIG. 9;

FIGS. 12A-12C are schematic diagrams of parisons injection molded in the apparatus of FIGS. 9-11 showing the locations of various measurements;

FIG. 13A is a schematic view illustrating the “lip curl” of a conventional blow-molded plastic cup;

FIG. 13B is a schematic view illustrating the solid-bead fortified rim of a tumbler produced in accordance with the present invention;

FIG. 14 is a view in elevation of a tumbler constructed in accordance with the present invention;

FIGS. 15A-15C are photomicrographs of the interior surface of a tumbler produced from a parison injection molded about a microtextured core;

FIGS. 16A-16C are photomicrographs of the interior surface of a tumbler produced from a parison injection molded about a smooth core; and

FIG. 17 is a schematic diagram of a stack of nested disposable tumblers.

### DETAILED DESCRIPTION

The invention is described in detail below for purposes of illustration only. Modifications within the spirit and scope of the present invention, set forth in the appended claims, will be readily apparent to those of skill in the art. As used herein, the terminology “polyethylene terephthalate”, “PET”, “PET resin”, “polyethylene terephthalate resin” and the like refers to polyester materials which consist primarily (more than about 75 mol percent) of repeat units corresponding to the residue of terephthalic acid and ethylene glycol. Such materials are well known; one suitable class of materials for making the tumblers of the invention are sometimes referred to in the art as “bottle resin”. One particularly preferred resin, available from Eastman Chemical Co., is EN058 PET resin which has an intrinsic viscosity of 0.58. Preferred configurations of equipment and process steps are described generally in U.S. Pat. No. 4,540,543, the disclosure of which is incorporated herein in its entirety.

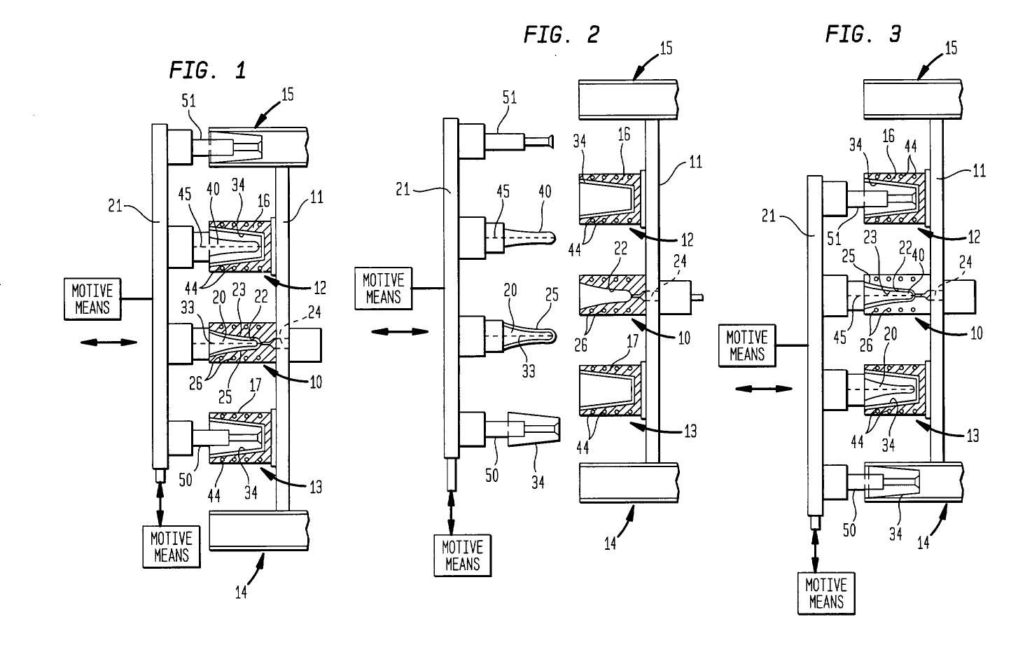

The process of the present invention is described below in connection with the various figures. Referring to FIGS. 1-3, injection station 10 is secured in fixed platen 11. Blow stations 12 and 13 are also secured to fixed platen 11 and are situated adjacent injection station 10 and in side-by-side relationship with respect thereto, with blow station 12 containing blow mold 16 which may be split if desired being on one side of the injection station and blow station 13 containing blow mold 17 which may be split if desired being on the other side. Blow molds 16 and 17 are in the shape of the hollow articles to be made. Ejection stations 14 and 15 are also secured to fixed platen 11 and are situated adjacent the respective blow stations in side-by-side relationship with respect thereto, with ejection station 14 situated adjacent blow station 13 and ejection station 15 situated adjacent blow station 12. Core 20 is provided secured to movable platen 21 engageable with injection station 10 as shown in FIGS. 1 and 3. The injection station 10 includes mold wall 22. Thus, when core 20 is engaged with injection station 10 as shown in FIG. 1 the core 20 is spaced from the mold wall 22 to form mold cavity 23 therebetween. Injection means 24 is in communication with mold cavity 23 and is connected to a source of hot flowable plastic, i.e., polyethylene terephthalate resin for forcing said hot formable plastic under pressure into mold cavity 23 to form parison 25. Core 20 is movable into and out of engagement with injection station 10 by movable platen 21 actuated by the motive means shown schematically in FIG. 1 and to be described in more detail herein below. Naturally, the movement of platen 21 may be accomplished by conventional means, shown schematically in FIG. 1, which are capable of providing a clamping force between the two platens to keep them from separating during the injection step and the other steps which will be described below. It should be understood that while movement of platen 21 is described, one may of course move platen 11 or both platens 11 and 21, if desired. The hot, newly formed parison or container 25 remains in mold cavity 23 until sufficiently cooled to be removed, if desired using cooling means 26 adjacent mold wall 22, as for example, by fluid circulation. If desired, such cooling means may also be provided in core 20. After such cooling of parison 25, the clamping force is released and platen 21 is moved away from platen 11 carrying with it core 20 and parison 25 adhered thereto. If a neck mold is used as to form a threaded neck portion the neck mold is operable by conventional means and remains closed during the formation of the parison, removal of the parison from the injection station and blowing, which also aids in retention of the parison on the core. A neck mold is not required and both the parison and final article have a cup-shaped configuration as seen in the drawings. In such configuration, the top or mouth of the container (mold) is about as wide or wider than the diameter of the remainder of the container mold.

Parison 25 has a base portion 30, a fortified brim or lip 31 and outwardly flaring sidewalls 32 extending from base 30 to lip 31. Fortified rim 31 may serve as an undercut to aid in retention of the parison on the core. Core 20 is provided with fluid passageway 33 connected to a source of fluid pressure for blowing the final article. If desired, a vacuum may be drawn through passageway 33 to aid in retention of the parison on the core. Core 20 with parison 25 thereon is then moved to blow station 13 as shown in FIGS. 2 and 3 in a manner which first separates the parison from the mold wall 22 by moving parison core 20 axially in a straight path away from said mold wall at least until the parison clears the injection station, followed by movement in a substantially arcuate path into axial alignment with blow station 13 and blow mold 17, followed by moving the parison core axially in a straight path into blow mold 17. Parison 25 is then expanded on core 20 in blow mold 17 to the blow mold surface by fluid pressure through passageway 33 to form a tumbler 34. FIG. 1 shows core 20 engaged with the injection station. FIG. 2 shows core 20 with parison 25 thereon removed from the injection station on its arcuate path between injection station 10 and blow station 13 with platen 21 and core 20 at the peak of their arcuate path. FIG. 3 shows core 20 engaged with blow station 13 forming tumbler 34 therein. After the formation of hollow article 34, core 20 is removed from blow station 13 leaving hollow article 34 remaining therein and returned to the injection station along paths corresponding to the path taken by core 20 from the injection station 10 to the blow mold 17, that is, the core is moved axially in a straight path away from blow mold 17 followed by movement in a substantially arcuate path into axial alignment with said injection station, followed by movement axially in a straight path into said injection station for repeat of the cycle.

Second core 40 having fluid passageway 45 similar to passageway 33 is provided on movable platen 21 adjacent core 20 in side-by-side relationship with respect thereto. Second core 40 is engageable with injection station 10 when core 20 engages blow mold 17 to form a second parison in an overlapping cycle with respect to core 20. Thus, second core 40 engages injection station 10 to form a parison 25 in a manner similar to the formation of a parison on core 20 in the injection station 10. The formation of a parison on core 40 takes place while core 20 is in the blow mold 17 forming the hollow article. Core 40 carrying a parison 25 is then removed from the injection station and transferred to blow station 12 and blow mold 16 in a path corresponding to the transfer path of core 20 to blow station 13 and blow mold 17 for formation of additional tumbler 34 in blow mold 16. The transfer of core 40 to blow mold 16 takes place simultaneously with the return of core 20 to injection station 10.

After removal of core 20 from blow station 13 tumbler 34 remains in blow mold 17. Tumbler 34 corresponds in shape very generally to parison 25 with an expanded configuration caused by the blowing step. Tumbler 34 has a base portion 41, fortified brim or lip 42 and outwardly flaring sidewalls 43 extending from base 41 to brim 42. The blown tumbler 34 cools in contact with the walls of the blow mold which may contain cooling means 44, as for example for cooling by fluid circulation in a conventional manner. Tumbler 34 may be retained in the blow mold by any desired means as by applying a vacuum to the inside of the blow mold or providing means on the blow mold to engage brim 42.

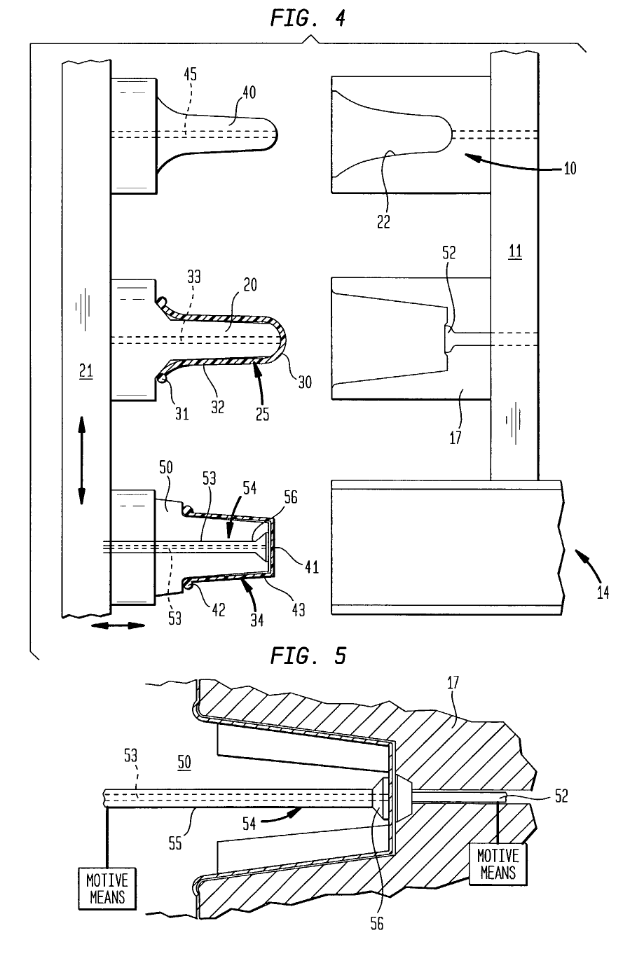

Ejection core 50 and second ejection core 51 are provided on movable platen 21 adjacent and in side-by-side relationship to cores 40 and 20, with ejection core 51 alongside second core 40. Thus, when cores 20 and 40 leave their respective blow molds 17 and 16 with the tumblers remaining therein for return to the injection station, ejection cores 50 and 51 move into engagement with said hollow articles in the blow molds along paths corresponding to the paths of cores 20 and 40. Cores 50 and 51 then disengage from the blow molds removing tumblers 34 with them and move from the blow stations to the ejection stations along paths corresponding to the paths of cores 20 and 40. Removal of tumbler 34 onto the ejection cores may be assisted by pusher means 52 operatively associated with blow molds 16 and 17 for positively pushing tumbler 34 away from the blow molds, see FIGS. 4 and 5. Also, ejection cores 50 and 51 may be provided with fluid passageways 53 connected to a source of fluid pressure, see FIG. 5, which may be used to draw a vacuum and aid in removal of tumbler 34 from the respective blow molds. The formed tumbler is then transferred to the respective ejection station, which may incorporate any suitable ejection means as the chute, suction tube or other conventional means to convey plastic articles. Removal of tumbler 34 from the ejection cores 50 and 51 at ejection stations 14 and 15 may be assisted by flow pressure from passageway 53 and also by stripper 54 including stem 55 to which a widened cap 56 is attached (FIGS. 4 and 5) movable axially via motive means. After removal of tumbler 34 at the ejection stations the cycle is repeated.

In operation, the parison is transferred into blow mold 17 as above described and blown into final shape therein, followed by insertion of mandrel 50 which is shorter than the depth of the blow mold. In order to remove tumbler 34, pusher plate 52 is advanced forcing the tumbler onto mandrel 50 which is then withdrawn. If desired, vacuum may be applied through passage 53 better to assure adherence of tumbler 34 to the mandrel during withdrawal from the blow mold. Clearly, pusher plate 52 and the stripper cap 56 may also be used to shape the portion of article 34 between them. If a rim undercut is embedded in the blow mold, it is overcome to effect release from the blow mold by the action of pusher plate 52 which has a stroke at least sufficient for the length of said undercut, it being understood that a given article may exhibit more than one undercut. In this manner, sticking of the finished article to the blow mold is avoided. Subsequently, mandrel 50 carrying tumbler 34 is aligned with removal devices as described above and, since all relative movement between the mandrel and the blow mold may be precluded due to the close fit of the mandrel and the article at the neck of the article, which may be an interference fit or an undercut, and, if necessary due to the vacuum, the alignment will be consistent from cycle to cycle. Upon alignment with the ejection station, the vacuum if theretofore applied through channel 53 is released and stripper 54 is actuated to urge the article into engagement with the ejecting device by positive mechanical means. The advantage of this arrangement compared to previous practice is in its reliability, preventing interruptions of the operation and thereby improving efficiency. While the foregoing description shows a single injection mold and core set, it will naturally be understood that multiple injection mold and core sets may readily be employed, for example, arranged side-by-side or in several rows. The overlapping cycles enable plural operations to be conducted simultaneously. While core 20 is engaging injection station 10 to form a first parison, second core 40 is engaging blow mold 16 to form a tumbler 34, second ejection core 51 is ejecting a hollow article at ejection station 15 and ejection core 50 is engaging a hollow article at blow station 13 for removal thereof, with the axial, arcuate and axial movement described hereinabove providing a considerable advantage in reduction in cycle time. The so-called “dry cycle” is that part of the total operating cycle of the apparatus described in FIGS. 1-5 which is not attributable to process related factors but only to the mechanism.

The total cycle divides into the dry cycle and the process cycle. In an injection blow-molding operation the pressure molding of the parison typically takes longer than the finishing thereof by blowing or the removal of the finished product. These three steps overlap so that while one parison is being molded another is being blown and still another is being removed.

The axial, arcuate and axial movement described above substantially reduces the dry cycle time and thus reduces the overall cycle time. Referring to FIG. 8, the movements of movable platen 21 are shown diagrammatically, which will of necessity include the movement of the cores thereon. Thus, when platen 21 moves from the position in FIG. 1 to the position in FIG. 3 a given point on the platen will follow curve A. The return movement will follow curve B. As platen 21 moves away from platen 11 the section on curve A from location 60 to 61 represents movement from the closed position of FIG. 1 to that point at which movement of core 20 with parison 25 thereon may occur laterally without mechanical interference. As soon as location 61 is passed said point starts its lateral movement which is subdivided into three (3) sections, namely between locations 61 and 62 in which acceleration is taking place, then between 62 and 63 in which the velocity of the point is constant, followed by between 63 and 64 in which deceleration is taking place. Finally, locations 64 and 65 show the approach to the blow mold and the position shown in FIG. 3. Naturally, the actual shapes of the curve segments will depend on the mass being moved, with the segment being steeper the lighter the movement assembly. As indicated above, curve B depicts the reverse movement. These movements can be effected by any conventional means, e.g. fluid actuators or by cam action. If by fluid actuators, it is readily possible to initiate their movement and thus also that of platen 21 by a limit switch placed to be tripped by platen 21 as soon as said platen reaches the distance from platen 11 at which the lateral movement of core 20 can take place unimpeded. If by cam action, fixed cams in the shape of curves A and B of FIG. 8 may be used and platen 11 may be equipped with corresponding cam followers, to the effect that the axial movement of platen 21 will at the same time induce its lateral movement according to the cam path. Other means to produce the same result may be employed so long as the lateral movement of platen 21 is effectively controlled by its axial movement, whereby said lateral movement accommodates acceleration and deceleration of platen 21 according to the mass to be moved therewith. The advantage of this improved arrangement is evident from the gain in cycle time. Thus, in the case referred to hereinabove the dry cycle of the injection clamping apparatus is reduced from approximately 4 seconds to approximately 1.2 seconds, of which the lateral shifting of platen 21 takes only 0.4 to 0.5 seconds including acceleration and deceleration. This improvement is particularly noticeable in connection with mechanical, e.g. toggle or crank clamping mechanisms which are favored for rapid acting injection clamps over fluid actuated clamps. In the former, the clamping apparatus, which is of the “fixed stroke” type can be used to induce the movement of platen 21 during that portion of its opening and closing stroke respectively which is in excess of the minimum clearance between core 20 and mold 17.

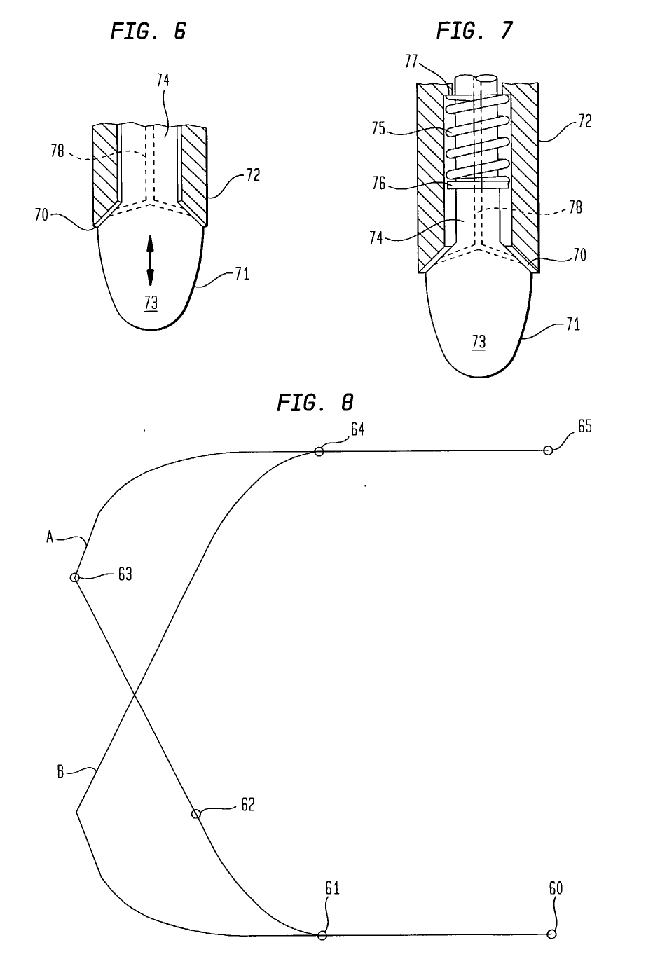

Cores 20 and 40 may be equipped with fluid passageways terminating in so-called blow slots 70 as shown in FIG. 7 in order to effect blowing of the preforms in the blow molds, as is known in the art. The blow slots may be located near the brim of the parison in preferred embodiments, as is further discussed below. If permanently open, the blow slot 70 is connected according to conventional design of a source of pressure fluid and a source of vacuum via fluid passageway 78 whereby the change from one to the other is effected by a conventional valve in order for the dual function of the blow slot to be readily accomplished as needed during injection and opening of the injection mold, and then during blowing. The blow slot may be formed of two elements of the core, for example leading element 71 and following element 72, that are capable of relative movement as shown in FIG. 6 by the arrow, with FIG. 6 showing the leading element being relatively moveable, with element 71 having a leading bulb-like portion 73 connected to a movable stem 74 which in turn is connected to a motive means. It is necessary to control the opening and closing of blow slot 70 mechanically in the following sequence: the blow slot is closed and held in that condition while injection of the plastic into the mold is initiated and almost immediately thereafter is opened; alternatively, it may be kept closed until the filling of the mold is accomplished and opened only thereafter. Vacuum is applied while the blow slot is open and maintained as core 20 or 40 is moved away from injection station 10 (see FIGS. 1 and 2). The blow slot remains open and vacuum is maintained while the preform moves from the injection station into the blow station, at which time, by suitable valving, the vacuum is broken and fluid pressure applied inside the preform to expand it into the shape of the finished article. At the end of the blowing cycle, the connection between the blow slot and the source of fluid pressure is interrupted, but vacuum is not admitted inside the finished article. Accordingly, in the case of an operable slot, the flow of fluid or connection to vacuum is controlled by a valve system that operates as follows: open to vacuum; closed to vacuum, open to pressureclosed to pressure, open to atmosphereclosed to pressure, closed to vacuum; blow slot closed FIG. 7 shows one embodiment of actuating the blow slot 70. As shown, a spring 75 is provided, urging the movable element 71 forming the blow slot to open the latter. Stem 74 is provided with a fixed annular bar 976. Spring 75 is affixed to stem 74 between bar 76 and internal ridge 77 on element 72. When inserted into the injection station, the entering plastic will tend to counteract the force of spring 75 closing the blow slot. When the pressure of the entering plastic is relieved, spring 75 will tend to open the slot again. However, if no vacuum is applied, then atmospheric pressure will tend to close the slot or counteract the spring. Accordingly, the spring force chosen has to be such as to maintain the blow slot open against the atmospheric pressure so that vacuum may be applied.

The total force due to atmosphere pressure counteracting the spring is of course one atmosphere times the projected area of the movable portion of the core assembly. Accordingly, the force of the spring will be chosen well above that level, for example, twice or three times that much, it being noted that the pressure of the plastic during injection is many times higher so that even with a stronger spring the blow slot will still be closed during the injection step. Thus, the cores may be provided with means operative to close the blow slot under the pressure of incoming plastic and to open the blow slot when the pressure of the incoming plastic is relieved. If the blow slot is to be permanently open, it must of course be held to a dimension precluding clogging thereof by penetration of the plastic while under pressure. That dimension is accordingly chosen according to the viscosity of the plastic at pressure molding temperature. The faces of the corresponding blow core components forming the slot may be slightly tapered toward the outside as shown in FIGS. 6 and 7, i.e., the side facing away from the core, and they may be coated with a substance that prevents adhesion of the entering plastic to metal surfaces, e.g. teflon, nickel/teflon coatings or any other non-stick coating as is known in the art. Likewise, the entire core may be provided with a non-stick coating, if so desired. In consequence, any slight amount of penetration into the slot will be cured during the blowing step, at which time the plastic that will thus have entered the blow slot will be blown out. The above described apparatus features interact with the process, particularly because a critical relationship exists between the temperature of the plastic at any given stage and the rate and magnitude of the forming operation to which it is subjected.

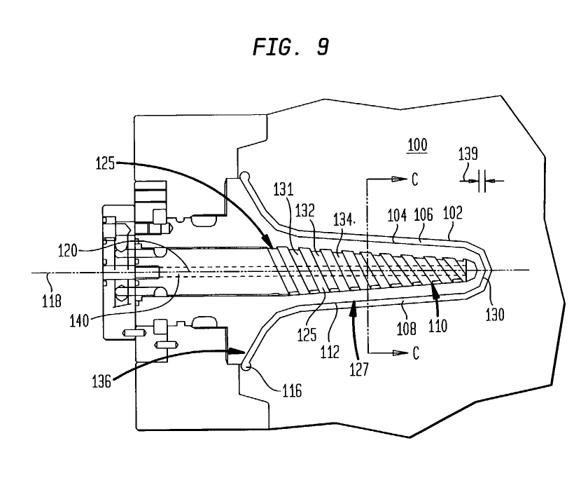

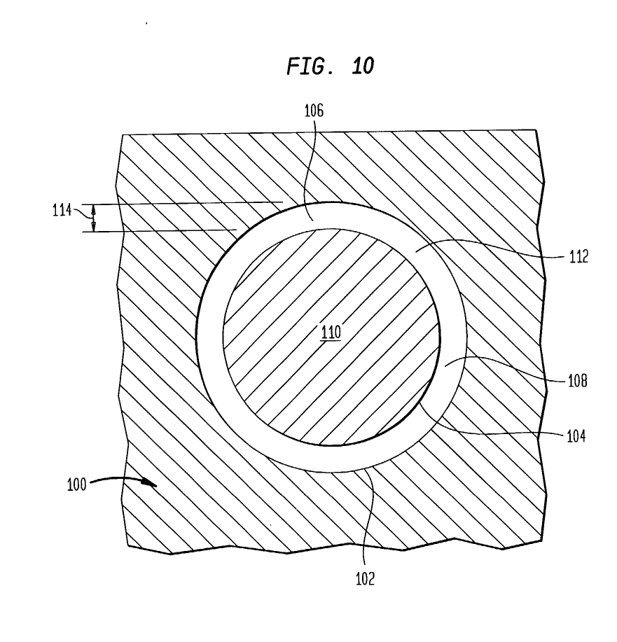

Indeed, when using polyethylene terephthalate resin to make the tumblers of the invention, the temperature of the resin, mold surfaces and geometry must be carefully controlled. Referring to FIGS. 9-11 there is shown schematically an injection mold 100 and an injection core 110 of the type which may be used in connection with the apparatus of FIGS. 1-5.

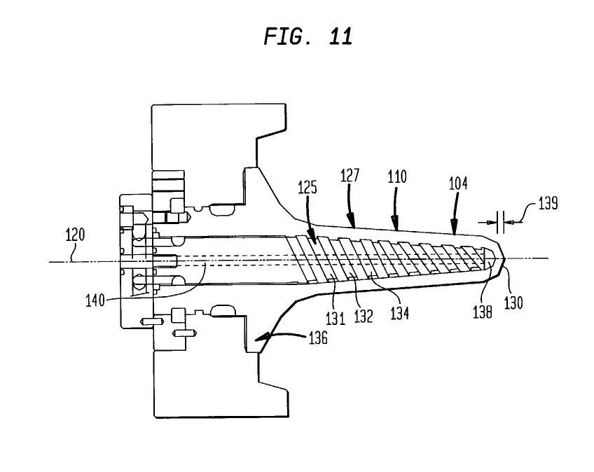

Injection mold 100 has an injection mold surface 102 which, together with injection core surface 104, define an injection mold cavity 106 for forming parison 108 as shown schematically in FIGS. 9 and 10. In FIG. 9, the core is shown engaged in the injection mold as descried above in connection with the apparatus of FIGS. 1-5, whereas various ancillary features have been omitted for purposes of illustration.

Advantageously, core surface 104 is a microtextured surface, produced by roughening surface 104 by vapor-honing, for example. Vapor honing is similar to grit-blasting but utilizes glass beads instead. It has been found that by forming the parison on a microtextured surface, the product tumblers resist nest-lock, that is, will have a reduced tendency to stick together when stacked. The core may be made from any suitable material, hardened steel such as H-13 tool steel hardened to specification Rockwell C-5254, for example, and then microtextured as described hereinafter. Treating the tumbler surface with water will likewise tend to reduce nest-lock, even if the free water is removed from the surface. Water may be wiped on to the surface of the tumblers, or alternatively, the tumblers may be subjected to a high humidity environment to impart nesting-lock resistance. Whatever treatment is used, it is preferred to preserve the glass-like clarity of the tumblers.

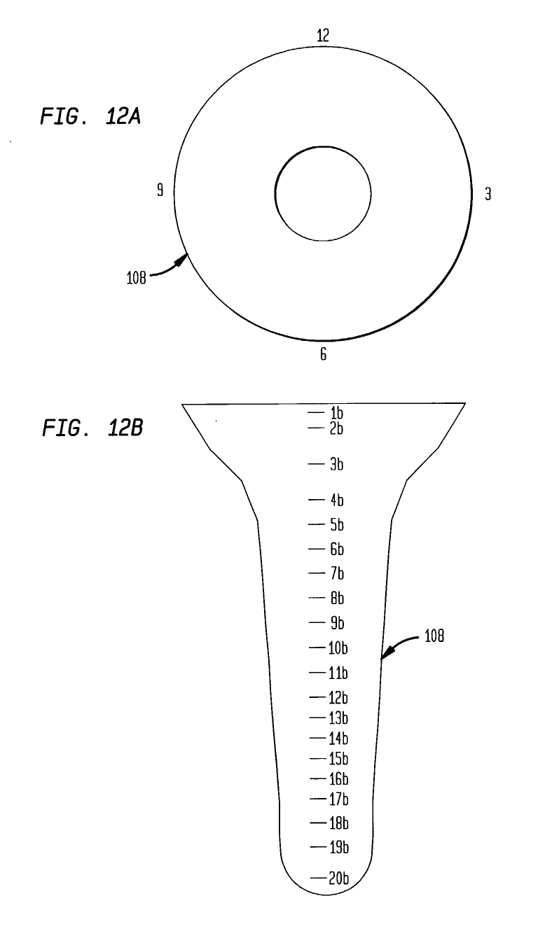

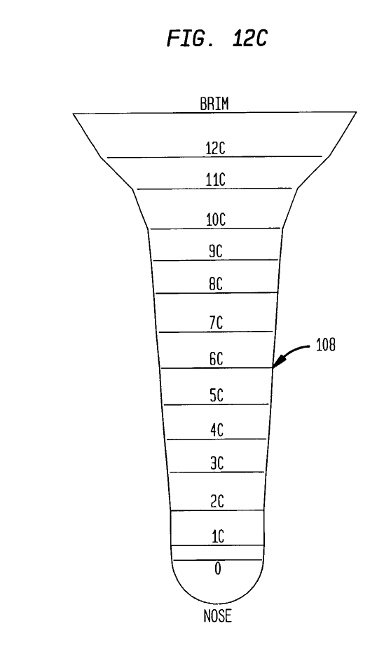

FIG. 10 is a view along line C-C of FIG. 9, showing in schematic cross-section annulus 112 of the cylindrical tapered cavity 106. Annulus 112 has an annular thickness 114 as indicated in FIG. 10 which generally has the dimensions discussed below in connection with FIGS. 12A-12C over the length of the parison. There is optionally provided in mold cavity 106 an upper bead 116 as shown in FIG. 9 to provide for a fortified brim of the product tumblers.

Making PET tumblers in accordance with the invention, particularly lightweight PET tumblers requires careful control of temperature and alignment of the molds, especially injection core 110 and mold 100. Surface 102 of mold 100 defines a central axis 118, whereas injection core 110 has a central longitudinal axis 120 which is aligned with axis 118 as shown in FIG. 9 during molding of parison 108. In conventional molding operations, the axis of the core and mold may be aligned, for example, within a tolerance of ±4 thousandths of an inch (4 mils). In molding the tumblers in accordance with the invention, axis 120 and axis 118 are aligned within a tolerance of ±2 mils and preferably within a tolerance of ±1.5 mils.

Injection core 110 is also provided with a cooling channel 125 which has a spiral configuration about an elongate rod like portion 127 of core 110 may extend to a nose portion 130 of the core. The spiral configuration includes a plurality of coils 131,132,134, for example, spaced apart along the length of the core. Lower portion 138 of channel 125 is within a distance 139 of less than about 0.15 inches of the outer surface of nose 130 of core 110.

Channel 125 is provided with cooling water via conduit 140 and the production process is controlled so that water temperature in the channel does not exceed about 195° F. and preferably is maintained at a temperature of about 185° F. or so. While blow slots may be located at various portions of the core, it has been found that it is preferred to locate the blow slots at 136, corresponding to the uppermost portions of the parisons and tumblers, that is near the brim.

The dimensions of mold cavity 106 and it various portions as well as the production process are further illustrated in connection with FIGS. 12A through 14.

FIG. 12A is a schematic plan view in section of parison 108 formed in cavity 106, that is, corresponding to the injection mold, whereas FIGS. 12B and 12C are schematic views in elevation of parison 108. In each case, the diagrams are labeled to indicate the location of measurements. In FIG. 12A the angular position about the annular parison is indicated for purposes of taking thickness measurements which correspond to the annular dimension of the mold cavity at a given location. Thickness measurements were taken at the 4 angular positions indicated as 12 o'clock, 3 o'clock, 6 o'clock and 9 o'clock on parison 108 at every ¼ inch or so, that is, at levels 1b, 2b, and so on as indicated on FIG. 12B and in Table 1. Results of the thickness measurements appear in Table 1 below for two parisons prepared in accordance with the invention.

TABLE 1
Parison (Injection Mold) Annular Dimensions

| | | Parison 1 | | | | | Parison 2 | | | | |
|---|---|---|---|---|---|---|---|---|---|---|---|
| Caliper (mils) | | 12:00 | 3:00 | 6:00 | 9.00 | Avg. | 12:00 | 3:00 | 6.00 | 9.00 | Avg. |
| Position 1b | near brim | 23.2 | 24.9 | 24.6 | 22.9 | 23.9 | 25.3 | 25.3 | 25.5 | 26.7 | 25.7 |
| Position 2b | ¼″ from brim | 24.8 | 26.4 | 26 3 | 24.4 | 25.5 | 27.1 | 26.5 | 26 7 | 28.1 | 27.1 |
| Position 3b | | 26.8 | 27.8 | 27.6 | 26.4 | 27.2 | 28.1 | 27 8 | 27.5 | 29 6 | 28.3 |
| Position 4b | 1″ from brim | 28.9 | 29 7 | 29.1 | 28.0 | 28.9 | 29.6 | 29.4 | 28.5 | 29.9 | 29.4 |
| Position 5b | | 29.5 | 29.9 | 29.6 | 28 2 | 29.3 | 29.9 | 30.0 | 29.0 | 29.6 | 29.6 |
| Position 6b | | 31.3 | 30.5 | 29.9 | 29.7 | 30.4 | 32 | 31 2 | 30.1 | 30 1 | 30.9 |
| Position 7b | | 36.1 | 35.8 | 34.8 | 36.0 | 35.7 | 35.4 | 36 2 | 35.3 | 34 1 | 35.3 |
| Position 8b | | 37.1 | 36.4 | 35.8 | 36.9 | 36.6 | 35.8 | 37.2 | 36.0 | 34.9 | 36.0 |
| Position 9b | | 37.7 | 37 1 | 36.9 | 36.6 | 37.1 | 36.7 | 37.7 | 36 0 | 35.5 | 36.5 |
| Position 10b | | 37.8 | 37.3 | 37.8 | 37.4 | 37.6 | 37.1 | 38.1 | 36.1 | 35.8 | 36.8 |
| Position 11b | | 38.3 | 36.5 | 37.2 | 38.6 | 37.7 | 37.7 | 38 4 | 36.9 | 35.9 | 37.2 |
| Position 12b | center | 38 8 | 36.5 | 37.9 | 39.5 | 38.2 | 37.7 | 38.9 | 37.2 | 36.3 | 37.5 |
| Position 13b | | 38.7 | 36 7 | 38 0 | 39.5 | 38.2 | 38.8 | 38 3 | 37 5 | 36.6 | 37.8 |
| Position 14b | | 39.0 | 37.3 | 38.6 | 40.0 | 38.7 | 39.1 | 38.8 | 37 3 | 36.8 | 38.0 |
| Position 15b | | 39.3 | 37.7 | 38 3 | 42.2 | 39.4 | 39.3 | 39.5 | 37 5 | 37.2 | 38.4 |
| Position 16b | | 39.0 | 38.1 | 38.4 | 41 7 | 39.3 | 39 2 | 40 1 | 37.9 | 37.7 | 38.7 |
| Position 17b | 1″ from bottom | 39.7 | 38.6 | 39.0 | 42 8 | 40.0 | 39.6 | 41.0 | 38.1 | 38 0 | 39.2 |
| Position 18b | ¾″ from bottom | 40.6 | 38.7 | 39.2 | 42.8 | 40.3 | 39.2 | 40.9 | 37.8 | 38.4 | 39.1 |
| Position 19b | ½″ from bottom | 40.9 | 39.1 | 39.2 | 42.4 | 40.4 | 39.8 | 40.8 | 38 4 | 37.5 | 39.1 |
| Position 20b | Near bottom | 42.9 | 40.6 | 40.8 | 45.3 | 42.4 | 41.6 | 41.5 | 40.0 | 39.6 | 40.7 |

Unless otherwise indicated, thickness and other dimensions refer to average dimensions.

As can be appreciated from Table 1, the mold cavity annular dimension and thickness of the parison (and cavity) progressively increases from its top portion or upper sidewall portions at positions 1b, 2b, 3b to its base at positions 17b, 18b and so on.

Likewise, the interior ring diameter of parison 108 prepared in accordance with the invention was measured at the heights 0, 1c, 2c and so on to near the brim of the parison at location 12c as indicated in Table 2 below and on FIG. 12C.

TABLE 2
Parison (Mold) Diameter Profile

| | Distance |
|---|---|
| | between rings |
| Span | (in.) |
| Nose - Ring 0 | 0.458 |
| Ring 0 - Ring 1c | 0.151 |
| Ring 1c - Ring 2c | 0.363 |
| Ring 2c - Ring 3c | 0.395 |
| Ring 3c - Ring 4c | 0.342 |
| Ring 4c - Ring 5c | 0.362 |
| Ring 5c - Ring 6c | 0.381 |
| Ring 6c - Ring 7c | 0.374 |
| Ring 7c - Ring 8c | 0.404 |
| Ring 8c - Ring 9c | 0.342 |
| Ring 9c - Ring 10c | 0 332 |
| Ring 10c - Ring 11c | 0 415 |
| Ring 11c - Ring 12c | 0 329 |
| Ring 12 - Brim | 0.467 |
| | Ring Diameter |
| Location | (in.) |
| Ring 0 | 0.95 |
| Ring 1c | 0.97 |
| Ring 2c | 1.02 |
| Ring 3c | 1.08 |
| Ring 4c | 1 13 |
| Ring 5c | 1.17 |
| Ring 6c | 1.23 |
| Ring 7c | 1 28 |
| Ring 8c | 1.33 |
| Ring 9c | 1.39 |
| Ring 10c | 1.71 |
| Ring 11c | 2 36 |
| Ring 12c | 2.94 |

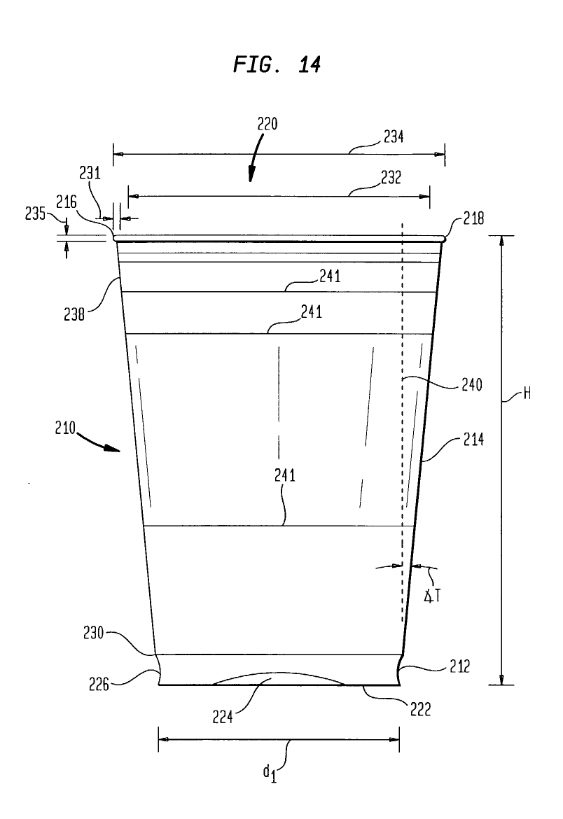

The parisons of the dimensions given above are formed into the tumblers of FIG. 14 by expanding them in their molten state, preferably using the injection blow molding process described in detail above. The parison is radially expanded mostly towards its base, that is, opposite the brim side. The brim may not be expanded at all, whereas the parison is radially expanded at its base by a factor of at least about 2.6. The expansion factor is calculated as the ratio of the diameter of the tumbler at its base (d₁ on FIG. 14) to the diameter of the parison from which it is formed at its base (ring o or ring 1c on FIG. 12C and in Table 2, for example). Thus, when a cylindrical (or frustoconical) tumbler having a diameter at its base of 3 inches or so is made from a cylindrical parison having a diameter of 1 inch at its base, the parison is radially expanded by a factor of 3 at its base as that terminology is used herein. Expansion factors of from about 2.6-3.25 are typical as noted above. In preferred embodiments of the polyethylene terephthalate tumblers of the invention, the tumblers have a beaded rim and the dimensions discussed below.

Polyethylene terephthalate has a specific gravity of 1.33 or so versus 1.04 or so for polystyrene. It has been found in accordance with the invention that substantially different processing conditions are required when making tumblers of equal interior volume and weight due to density and viscosity differences. In particular, the relatively thick parisons and relatively high expansion ratios of the present invention are advantageously employed.

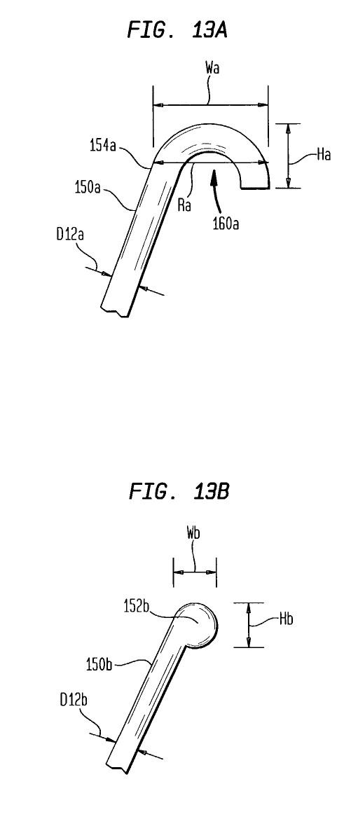

Referring to FIG. 13A, there is schematically depicted a lip curl characteristic of prior art disposable drinking cups. In general, such prior art cups have a sidewall 150a of a given thickness D12a which extends upwardly into a curl generally indicated at 160a. The curl has a characteristic radius Ra as well as a height Ha and a width Wa. Such structures are sometimes called “open top curls” and may be seen, for example, in U.S. Pat. No. 4,540,543. See FIG. 4 thereof at 31.

FIG. 13B schematically depicts in section and elevation a solid polymer bead about the upper periphery of a tumbler, that is, an embodiment of the fortified rim of the present invention which extends around the upper periphery of the inventive tumbler. The tumbler has a sidewall 150b of thickness D12b. The fortified rim or brim, 152b is formed of solid polymer integrally formed with sidewall 150b and has a height, H_{b}, and width, W_{b}, as indicated. The bead may be circular, however is more typically hemi-elliptical shaped with height, H_{b}, being about 70 mils and width, W_{b}, being about 100 mils. The beaded structure of brim 152b has advantages over the prior art top curl. For one, it rounded and will not tend to snag on the mold or snag with a cup cover as to prior art top-curls.

There is shown in FIG. 14 a tumbler 210 which is constructed in accordance with the present invention, that is prepared from a parison such as parison 108. In general, tumbler 210 is cylindrical or in the shape of a truncated cone and has a base portion 212, a sidewall portion 214 and an upper circular rim portion 216 which extends about the periphery 218 of an opening 220 of tumbler 210. Base portion 212 of tumbler 210 is integrally formed with the rest of the tumbler and includes a bottom 222 which has a meniscus portion 224 and a base sidewall 226. Base sidewall 226 is typically thicker than sidewall 214, and has either no taper, or reverse taper from the taper of sidewall 214.

Base sidewall 226 extends upwardly to define an outer edge 230 which attaches to sidewall 214. Sidewall 214 extends upwardly to fortified brim 216. Rim 216 is integrally formed with sidewall 214 and is a continuous generally circular or oval, solid polymer bead extending about periphery 218 of opening 220. Brim 216 has a width 231 which is defined by the difference between an inner diameter 132 and an outer diameter 234 of brim 216 and a height 235 which is the distance over which width 231 extends. Width 231 is thicker than adjacent sidewall portion 238 which is typically of the same caliper as the rest of sidewall 214, that is, sidewall 214 is substantially uniform in thickness on the entire tumbler. For a nominal 16 ounce container volume tumbler, sidewall portion 238 may have a thickness or caliper of 20 mils or less, height 235 may be approximately 70 mils and width 231 of brim 216 may be approximately 100 mils at its thickest point. The tumbler is also provided with a series of molded-in grooves 241 which extend around the tumbler. These grooves provide a grip for a user as well as providing rigidity to the article. Typically, the circumferential grooves 241 have a depth of from 10 to 40 mils.

Other dimensions of tumbler 210 are indicated on FIG. 13 and may be as follows for a nominal 16 ounce container volume tumbler: base portion 212 has a diameter d1, at edge 230 of about 2.5 inches, an outer upper diameter 234 of about 3.4 inches and an inner upper diameter 232 of about 3.35 inches. The overall height, H of tumbler 210 is about 4.6-4.75 inches. These dimensions define an angle of taper T as shown about imaginary axis 240 of about 5° for sidewall 214 of tumbler 210. As used herein, “taper”, “degree of taper” or like terminology indicates the angle that the sidewall of the inventive tumbler makes with the longitudinal axis defined by the sidewall which is substantially cylindrical or conical depending upon the embodiment. Inasmuch as the sidewall is substantially perpendicular to bottom 222, the taper may also be thought of as of the angle the sidewall makes with the bottom less 90 degrees, because the axis of the tumbler is substantially perpendicular to bottom 222 as shown.

A nominal 16 ounce container volume tumbler is one which will hold 16 fluid ounces when filled to a level substantially below its brim, up to ¼ inch or so. Typically, such containers will hold about 18 ounces actual volume when filled to the top of their brims. Wall caliper (thickness) at various heights for the tumblers of the invention and various thermoformed PET products are listed in Table 3 and physical properties are given in Table 4.

TABLE 3
Tumbler Wall Caliper (Appx.)

| | Thickness (Mils) | | | |
|---|---|---|---|---|
| | IBM PET of | | | |
| | Invention | Thermoformed A | Thermoformed B | Thermoformed C |
| Product Height | (16 oz. nominal) | (16 oz. nominal) | (12 oz.) | (12 oz.) |
| ¼″ from brim | 19 | 27 | 20 | 26 |
| 1″ from brim | 13 | 17 | 17 | 14 |
| 2½″ from brim | 12 | 11 | 12 | 16 |
| (center) | | | | |
| 1″ from bottom | 17 | 10 | 11 | 12 |
| Reverse Taper | 12 | 10 | 9 | 16 |

TABLE 4
Typical Physical Properties of PET Tumblers

| | Property | | | |
|---|---|---|---|---|
| | | | Brim | Bottom |
| | | | Resistance | Resistance |
| Product | Weight (g) | Rigidity (lb_{f}) | (lb_{f}-in) | (lb_{f}-in) |
| IBM PET of | 17.70 | 0.47 | 14.8 | 18.05 |
| Invention | | | | |
| (16 oz. nominal) | | | | |
| Thermoformed A | 16.55 | 0.72 | 14.8 | 14.1 |
| (16 oz. nominal) | | | | |
| Thermoformed B | 14.00 | 0.79 | 11.88 | 13.6 |
| (12 oz.) | | | | |
| Thermoformed C | 20.95 | 0.90 | 12.82 | 19.35 |
| (20 oz.) | | | | |

In the foregoing tables, rigidity is the force required to compress the sidewalls of a tumbler 0.25 inches. The measurement is made with a JS-1 Rigidity Tester modified with a Chatillon force gauge. The test instrument is available from Georgia-Pacific Corporation, Neenah Technical Center, Neenah, Wis. The force gauge is available from Chatillon, Greensboro, N.C. The particular procedure employed to generate the data recited above involved securing the tumbler on a platen about its base and the force required to compress the sidewalls of the cup 0.25 inches at ⅔ of its height was determined.

Brim resistance was determined in a test whereby the tumblers (or tumbler stack in the case of a nested column) were clamped about their bases to be in a free-standing position and a cylindrical suspended weight was positioned to be at rest with its cylinder wall adjacent the rim of the tumbler. The weight was then drawn to a predetermined angle from the vertical and released. The angle with vertical at failure was recorded and the energy dissipated at impact was calculated based on the height to which a cylindrical weight was raised above the rest position.

Bottom resistance is measured by determining the energy needed to crease or break the bottom of a stack of two cups by an impact force. A stack of two cups is placed in a wooden ring support, bottom side up, in contact with a rod. A weight is released to impact the rod from progressively greater heights until a cup bottom starts to crease or break or the cups lock together. The energy required to induce failure is then calculated based on the weight and the height from which it is released.

In addition to thickness and physical properties, tumblers of the invention were compared with thermoformed tumblers for clarity. Haze values appear in Table 5.

TABLE 5
Haze Values of Various PET Tumblers

| | Product | | |
|---|---|---|---|
| | PET IBM | Thermoformed | Thermoformed |
| | Invention | A | D |
| | 16 oz nominal | 16 oz nominal | 16 oz |
| Measured | 0.94 | 1.06 | 3.70 |
| Haze | 1.01 | 1.02 | 4.06 |
| Values | 0.73 | 0.92 | 3.43 |
| | 0.75 | 1.25 | 3.45 |
| | 0.88 | 1.14 | 3.60 |
| Average | 0.86 | 1.08 | 3.65 |

Haze values in Table 5 were measured using an XL-211 Hazeguard Hazemeter (BYK-Gardner, Inc.) calibrated with a Geometric Test Standard (GTS) by simply placing a sidewall sample at the entrance port of the sensing unit.

The tumblers of the invention are preferably provided with a microtextured surface by forming a parison such as parison 108 on a roughened core so that the tumbler has a microtextured inner surface. In a preferred embodiment, the cores were sand blasted, that is, vapor-honed with “BT-08” glass beads produced by Flex-O-Lite, Inc., Chesterfield, Mo., utilizing a pneumatic sandblasting gun in a pressure range between 30 and 100 psi. Following this surface treatment the cores were draw polished. The glass beads were 70/100 mesh and meet military specification MIL G9954A.

Ten cups produced from vapor honed cores were contrasted to ten cups produced from non-vapor honed cores using the following procedure: Each set of ten cups were nested and placed on a flat surface bottom side up. A five-pound weight was placed on each set for a period of five minutes. Each set was then placed right side up and evaluated for de-nesting characteristics. De-nesting was attempted by pulling cups vertically from their nested position while griping the brim of the upper most cup with one hand. Following this cups that did not separate were evaluated for difficulty of separation when using both hands. The results of this evaluation were as follows:

Six of the ten non-vapor honed cups did not de-nest when lifted from the nested stack with one hand and could not be de-nested without considerable difficulty when using both hands.

Three of the ten vapor honed cups did not de-nest initially with one hand but easily separated when using both hands.

Thus, tumblers with microtextured surfaces in accordance with the invention exhibited at least a 50% reduction in their tendency to exhibit nest-lock. Similar results have been obtained by using water treatment. In general, the texturing and surface treatment with water is believed to be effective on a wide variety of PET disposable tumblers of various thicknesses and geometries.

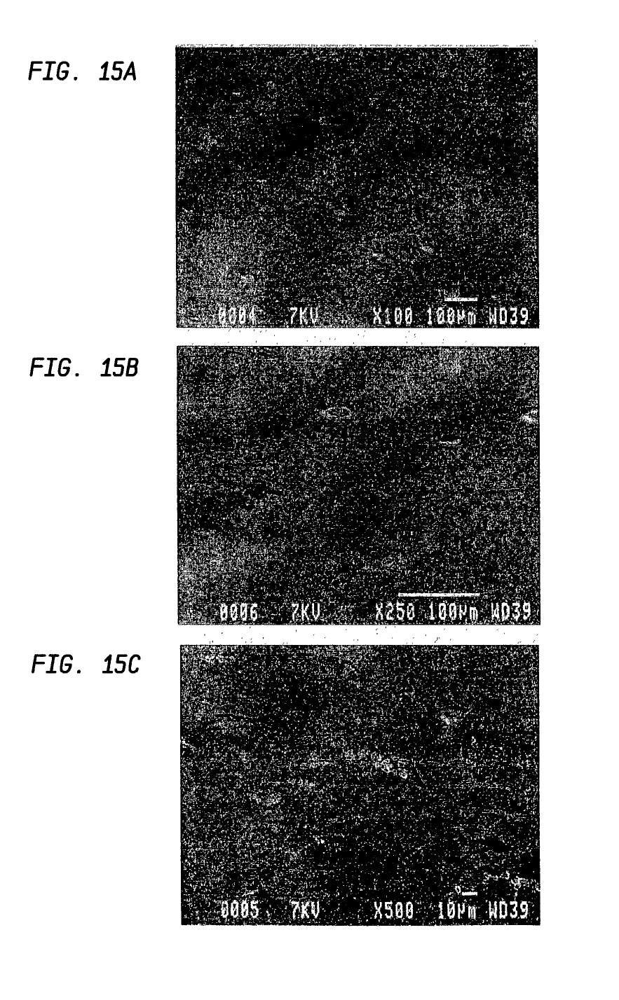

By the term “microtextured” it is meant that at least one surface of the tumblers has enough roughness to substantially reduce nesting-lock tendency by the above test, for example by at least about 30% over smooth-walled PET tumblers of like construction, without altering substantially the glass-like clarity of the product. A particularly preferred tumbler surface is one which has glass-like clarity and small surface voids or protuberances which are visually imperceptible having characteristic dimensions on the order of 5 to 40 microns as can be seen in FIGS. 15A-15C. Characteristic texture dimensions can be calculated for irregularly shaped voids (or raised portions) by measuring its maximum and minimum spans and taking the square root. The microtexture may occupy as little as 0.01% of the surface area and typically occupies less than 20 percent of the interior surface of the tumbler

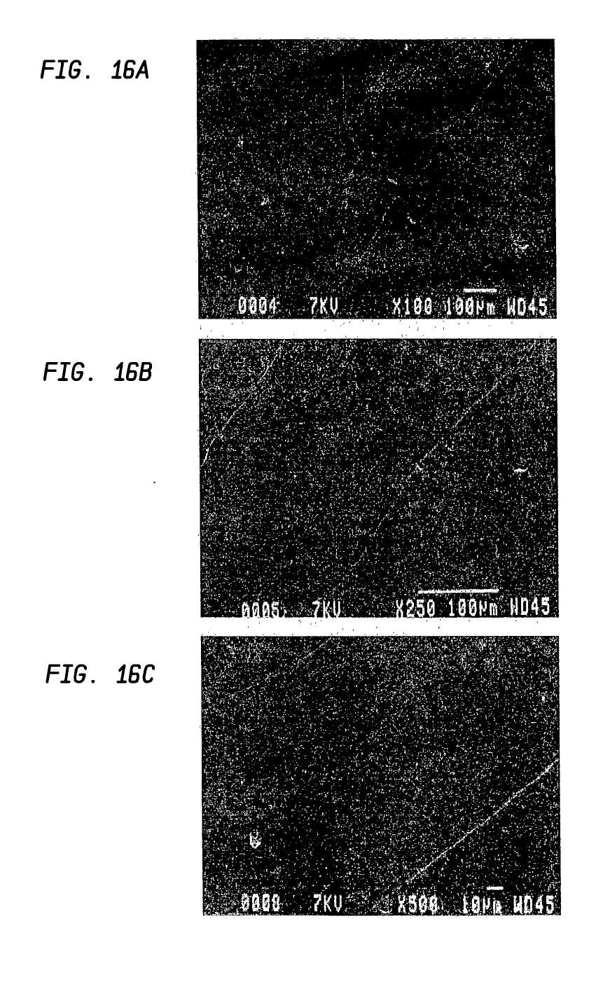

FIGS. 15A-15C are photomicrographs of an interior tumbler surface prepared from a core vapor-honed with BT-08 glass beads as noted above. As can be seen, the surface is replete with small surface voids having characteristic microtexture dimensions of from about 5-40 microns. FIGS. 16A-16C, on the other hand, are corresponding photomicrographs of the interior surface of a tumbler prepared by the same process. As can be seen from these photomicrographs, the surface is substantially smooth and, based on the test data, tends to be quite cohesive with like surfaces when the tumblers are stacked.

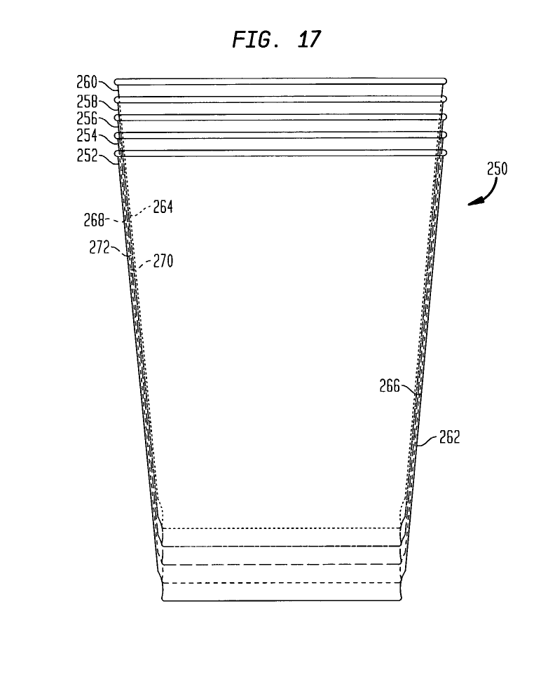

There is shown schematically in FIG. 17 a nested stack 250 of tumblers 252, 254, 256, 258 and 260 wherein the sidewalls of tumblers are configured to resist nest-lock as noted above. Each tumbler has an outer surface 262 of tumbler 252 and an inner sidewall surface such as inner surface 264 of tumbler 260. In nested stack 250 each outer tumbler sidewall surface contacts the outer sidewall surface of the next inner tumbler. Thus inner sidewall surface 266 of tumbler 252 contacts outer sidewall surface 268 of tumbler 254 and the inner sidewall surface 270 of tumbler 254 contacts the outer sidewall surface 272 of tumbler 256 and so forth.

In a particularly preferred embodiment nested stack 250 is produced with a plurality of tumblers which have microtextured inner sidewall surfaces to reduce nest lock. It may be possible to microtexture the outer sidewall surfaces as well. Alternatively, the inner and/or outer sidewall surfaces are treated with water. The water may optionally include an antiseptic agent and may be applied directly to the sidewall surfaces by spraying wiping or the like or the tumblers may simply be placed in a high relative humidity environment and allowed to sorb moisture. In this manner, moisture may be applied to both the inner and outer sidewall surfaces of the tumblers. If so desired, free water may be removed from the sidewall surfaces of the cups so that they are not wet to the touch prior to stacking. Even when the sidewall surfaces are devoid of free water, the moisture treatment is effective to reduce nest-lock.

While the invention has been described and illustrated in detail in connection with numerous features thereof, modifications to specific illustrated or exemplified embodiments within the spirit and scope of the invention, set forth in the appended claims, will be readily apparent to one of skill in the art.

What is claimed is:

1. A method of making a disposable tumbler comprising:
(a) injection molding polyethylene terephthalate resin in an annular mold cavity defined by an injection mold wall and a core to form a resinous parison on the core;
(b) separating the parison from the injection mold wall by moving the parison on the core away from the mold wall;
(c) moving the parison on the core into alignment with a blow-mold; and
(d) expanding the parison by directing a pressurized fluid to its interior such that said parison separates from the core and expands to the surface of the blow mold to form said tumbler, wherein the parison is radially expanded by a factor of at least about 2.6 at its base when forming said tumbler.

2. The method according to claim 1, wherein the parison is radially expanded by a factor of from about 2.6 to about 3.25 at its base when forming said tumbler.

3. The method according to claim 2, wherein the parison is radially expanded by a factor of from about 2.7 to about 2.9 at its base when forming said tumbler.

4. The method according to claim 1, wherein said core is provided with a microtextured surface.

5. The method according to claim 4, wherein said core is provided with a microtextured surface by way of a technique selected from the group consisting of vapor honing, grit blasting, lapping, or chemical etching.

6. The method according to claim 5, wherein said microtextured surface of said core is provided by vapor-honing.

7. The method according to claim 6, wherein said core is vapor-honed with a pneumatic sand-blasting apparatus utilizing an air pressure of from about 30 to about 100 psi.

8. The method according to claim 7, wherein said core is vapor-honed utilizing glass beads having a size in the range of from about 70 to about 100 mesh.

9. The method according to claim 1, wherein said annular mold cavity has an annular thickness at its portion corresponding to the base of the parison of from about 35 mils to about 45 mils.

10. The method according to claim 9, wherein said annular mold cavity has an annular thickness at its portion corresponding to the base of the parison of from about 37 mils to about 43 mils.

11. The method according to claim 1, wherein said core is provided with a cooling channel adapted to receive cooling water which is supplied to said core and wherein the cooling water is maintained in said core below a maximum temperature of about 195° F.

12. The method according to claim 11, wherein the cooling water is maintained in said core at a temperature of about 185° F.

13. The method according to claim 11, wherein said core is an elongate core having a rod portion underlying the sidewalls of said parison and a nose portion underlying the end portion of said parison and wherein said rod portion is provided with at least one spiral cooling channel and said nose portion of said core is provided with a cooling channel within about 0.15 inches of the surface of said nose portion.

14. The method according to claim 11, wherein said nose portion of said core is provided with a cooling channel with about 0.125 inches of the surface of said nose portion.

15. The method according to claim 1, wherein the injection mold outerwall is characterized by a centerline and said core is aligned with said centerline within a tolerance of 2 mils during said step of injection molding.

16. The method according to claim 15, wherein said core is aligned with said centerline within a tolerance of about 1.5 mils during said injection molding process.

17. A method of making a disposable tumbler comprising:
(a) injection molding polyethylene terephthalate resin in an annular mold cavity defined by an injection mold wall and a core to form a resinous parison on the core;
wherein said cavity is of progressively greater annular dimension from its portion corresponding to the upper sidewall portion of said parison to the base of said parison;
(b) separating the parison from the injection mold wall by moving the parison on the core away from the mold wall;
(c) moving the parison on the core into alignment with a blow-mold; and
(d) expanding the parison by directing a pressurized fluid to its interior such that said parison separates from the core and expands to the surface of the blow mold to form said tumbler.

18. The method according to claim 17, wherein said cavity has an annular dimension of from about 15 mils to about 30 mils at its portion corresponding to the upper sidewall portion of said parison and an annular dimension of from about 35 mils to about 45 mils at its portion corresponding to the base of said parison.

19. The method according to claim 18, wherein said cavity has an annular dimension of from about 37 mils to about 43 mils at its portion corresponding to the base of the parison.

20. The method according to claim 17, wherein said core is provided with a microtextured surface.

21. The method according to claim 20, wherein said core is provided with a microtextured surface by way of a technique selected from the group consisting of vapor honing, grit blasting, lapping, or chemical etching.

22. The method according to claim 21, wherein said core is provided with a microtextured surface by way of vapor-honing.

23. An injection blow-molded polyethylene terephthalate tumbler formed by way of injection molding a parison about a core and expanding the parison by way of directing a pressurized fluid to its interior such that the parison separates from the core and expands to the surface of a blow mold to form the tumbler, wherein the parison is radially expanded by a factor of at least about 2.6 at its base when forming the tumbler.

24. The injection blow-molded polyethylene terephthalate tumbler according to claim 23, wherein the volume of said parison is radially expanded by a factor of from about 2.5 to about 3.25 at its base when forming the tumbler.

25. The injection blow-molded polyethylene terephthalate tumbler according to claim 24, wherein the parison is radially expanded by a factor of from about 2.7 to about 2.9 at its base when forming said tumbler.

26. The injection blow-molded polyethylene terephthalate tumbler according to claim 23, formed about a core provided with a microtextured surface such that the interior sidewall surface of said tumbler has a microtextured surface.

27. The injection blow-molded polyethylene terephthalate tumbler according to claim 23, conditioned to reduce its tendency to lockably nest with like tumblers in a stack by treatment of at least one surface thereof with water.

28. The injection blow-molded polyethylene terephthalate tumbler according to claim 27, wherein free water has been removed from its surfaces.

29. The injection blow-molded polyethylene terephthalate tumbler according to claim 23, wherein said tumbler has a nominal container volume of about 16 ounces and is made from less than about 20 grams of resin.

30. The injection blow-molded polyethylene terephthalate tumbler according to claim 23, wherein said tumbler has a nominal container volume of about 16 ounces and is made from less than about 18 grams of resin.

31. A method of producing a stack of polyethylene terephthalate tumblers with a reduced tendency to exhibit nest-lock comprising the sequential steps of:
(a) forming a plurality of polyethylene terephthalate stackable tumblers;
(b) moisture-treating at least one sidewall surface of each of said plurality of polyethylene terephthalate tumblers with an amount of water effective to reduce nest-lock to a level less than that exhibited by like tumblers which have not been moisture-treated; and
(c) stacking said plurality of moisture-treated polyethylene terephthalate tumblers such that said moisture-treated sidewalls are in contact with the sidewall of another tumbler in said stack.

32. The method of producing a stack of polyethylene terephthalate tumblers according to claim 31, wherein both the inner sidewall surface and the outer sidewall surface of said tumblers are moisture-treated.

33. The method of producing a stack of polyethylene terephthalate tumblers according to claim 31, wherein said moisture treatment is effective to reduce nest-lock by at least about 30 percent as compared with like tumblers that have not been moisture-treated.

34. The method of producing a stack of polyethylene terephthalate tumblers according to claim 33, wherein said moisture treatment is effective to reduce nest-lock by at least about 40 percent as compared with like tumblers that have not been moisture-treated.

35. The method of producing a stack of polyethylene terephthalate tumblers according to claim 31, wherein said plurality of polyethylene terephthalate tumblers are devoid of free water on their sidewalls prior to stacking.

36. The method of producing a stack of polyethylene terephthalate tumblers according to claim 31, wherein said plurality of polyethylene terephthalate tumblers have a wall caliper of from about 5 to about 30 mils.

37. The method of producing a stack of polyethylene terephthalate tumblers according to claim 31, wherein said plurality of polyethylene terephthalate tumblers have a wall caliper of from about 10 to about 25 mils.

38. A method of producing a stack of polyethylene terephthalate tumblers with a reduced tendency to exhibit nest-lock comprising:
(a) forming a plurality of stackable polyethylene terephthalate tumblers each of which has at least one microtextured sidewall surface which tumblers are substantially optically clear; and
(b) stacking said plurality of polyethylene terephthalate tumblers such that said microtextured sidewall surfaces contacts the sidewall of an adjacent tumbler in said stack, wherein said microtextured surfaces are operative to reduce the tendency of said tumblers to lockably nest with like tumblers.

39. The method of producing a stack of polyethylene terephthalate tumblers with a reduced tendency to exhibit nest-lock according to claim 38, wherein said plurality of polyethylene terephthalate tumblers have a wall caliper of from about 5 to about 30 mils.

40. The method of producing a stack of polyethylene terephthalate tumblers with a reduced tendency to exhibit nest-lock according to claim 39, wherein said plurality of polyethylene terephthalate tumblers have a wall caliper of from about 10 to about 25 mils.

41. The method of producing a stack of polyethylene terephthalate tumblers with a reduced tendency to exhibit nest-lock according to claim 38, wherein said microtextured surfaces are operative to reduce nesting lock by at least about 30 percent.

42. The method of producing a stack of polyethylene terephthalate tumblers with a reduced tendency to exhibit nest-lock according to claim 41, wherein said microtextured surfaces are operative to reduce nesting lock by at least about 40 percent.

43. The method of producing a stack of polyethylene terephthalate tumblers with a reduced tendency to exhibit nest-lock according to claim 38, wherein said microtextured sidewall surface has a characteristic texture dimension of from about 5 microns to about 40 microns.

44. The method of producing a stack of polyethylene terephthalate tumblers with a reduced tendency to exhibit nest-lock according to claim 43, wherein said microtextured sidewall surface has a characteristic texture dimension of from about 10 microns to about 25 microns.

45. A nesting-lock resistant polyethylene terephthalate disposable tumbler having a wall thickness of from about 5 to about 30 mils, said tumbler being provided with a microtextured surface and being substantially optically clear, wherein said microtextured surface is operative to reduce the tendency of said tumbler to lockably nest with like tumblers when stacked but does not substantially alter the aesthetics of said optically clear tumbler.

46. The nesting-lock resistant polyethylene terephthalate disposable tumbler according to claim 45, wherein said tumbler has a wall caliper of from about 10 to about 25 mils.

47. The nesting-lock resistant polyethylene terephthalate disposable tumbler according to claim 45, wherein said microtextured surface is operative to reduce nesting-lock by at least about 30 percent.

48. The nesting-lock resistant polyethylene terephthalate disposable tumbler according to claim 47, wherein said microtextured surface is operative to reduce nesting lock by at least about 40 percent.

49. The nesting-lock resistant polyethylene terephthalate disposable tumbler according to claim 45, wherein said microtextured surface has a characteristic microtexture dimension of from about 5 microns to about 40 microns.

50. The nesting-lock resistant polyethylene terephthalate disposable tumbler according to claim 49, wherein said microtextured surface has a characteristic microtexture dimension of from about 10 microns to about 25 microns.
